(19) United States
(12) Patent Application Publication
(10) Pub. No.: US 2022/0128760 A1
(43) Pub. Date: Apr. 28, 2022

(54) OPTICAL WAVEGUIDE SWITCH AND METHOD OF MAKING SAME

(71) Applicant: COMMSCOPE TECHNOLOGIES LLC, Hickory, NC (US)

(72) Inventors: Ana RADOSAVLJEVIC, Gent (BE); Andres DESMET, Ruddervoorde (BE); Jeroen MISSINNE, Gent (BE); Geert Firmin VAN STEENBERGE, Sint-Amandsberg (BE); Dries VAN THOURHOUT, Gent (BE); Salvatore TUCCIO, Kessel-Lo (BE); Vivek PANAPAKKAM VENKATESAN, Leuven (BE); Saurav KUMAR, Kessel-Lo (BE); Cristina LERMA ARCE, Destelbergen (BE); Jan WATTÉ, Grimbergen (BE)

(73) Assignee: COMMSCOPE TECHNOLOGIES LLC, Hickory, NC (US)

(21) Appl. No.: 17/423,062

(22) PCT Filed: Jan. 17, 2020
(86) PCT No.: PCT/US2020/014112

§ 371 Date: Jul. 14, 2021

Related U.S. Application Data
(60) Provisional application No. 62/794,228, filed on Jan. 18, 2019.
(60) Provisional application No. 62/866,275, filed on Jun. 25, 2019.

(51) Int. Cl. G02B 6/12; G02B 6/35; G02B 6/136

(52) U.S. Cl. CPC G02B 6/12007; G02B 6/136; G02B 6/3546

(57) ABSTRACT

The invention relates to the fabrication of optical switches in transparent substrates. The method includes exposing part of the substrate to a stream of femtosecond laser pulses to form an exposed volume which can later be etched to form a channel used for microfluidic control of the switch. This process is referred to as femtosecond laser induced chemical etching (FLICE). The waveguides of the optical switch are also written in the substrate by using femtosecond laser inscription (FLI), which can be performed in the same operation as the exposure step in the FLICE formation of the channel, thus ensuring alignment between the waveguides and the channel.

### CROSS-REFERENCE TO RELATED APPLICATIONS

This application is being filed on Jan. 17, 2020 as a PCT International Patent Application and claims the benefit of U.S. Patent Application Ser. No. 62/794,228, filed on Jan. 18, 2019, and claims the benefit of U.S. Patent Application Ser. No. 62/866,275, filed on Jun. 25, 2019, the disclosures of which are incorporated herein by reference in their entireties.

### FIELD OF THE INVENTION

The present invention is generally directed to optical communications, and more specifically to waveguide optical switches and method of making waveguide optical switches.

### BACKGROUND OF THE INVENTION

Optical fiber networks are becoming increasingly prevalent in part because service providers want to deliver high bandwidth communication and data transfer capabilities to customers. As optical networks become more complex, it has become increasingly important to manage optical signals in the network. Many optical signal management functions, such as redirecting signals to bypass faulty components, or opening new channels to facilitate the addition of more users of the network, can be accomplished using active optical switches, for example, totally internally reflecting waveguide (TIRW) optical switches. One approach to implementing a TIRW switch is based on the movement of a droplet of liquid under an applied force from, e.g. an applied pressure or an applied electric field. This approach is usually implemented with a narrow channel that crosses the waveguide. The liquid droplet is movable within the channel so as either to reflect the light at the channel wall into a second waveguide via total internal reflection at the channel wall or, where the liquid provides index-matching with the waveguide, to permit transmission of the light across the channel, depending on the position of the liquid droplet.

The features of a waveguide optical switch, including the waveguides and channel, are conventionally made using standard lithographic processes. For example, waveguides are fabricated in silica by diffusion or implanting processes through a mask, and the channel is fabricated using an etching technique such as reactive ion etching (ME). However, optimized switch design requires relatively deep but narrow channels, which are difficult to achieve using a conventional etching process. Furthermore, the need for multiple processing steps using different masks can lead to a reduction in the precision required to make a high quality component.

It is desirable, therefore, to develop improved techniques for fabricating TIR waveguide switches that can produce high precision components.

### SUMMARY OF THE INVENTION

An embodiment of the invention is directed to a method of forming an optical switch. The method includes exposing a first volume of material in a substrate to femtosecond laser light, where the first volume is selected to act as a channel in the optical switch. The exposed first volume in the substrate is etched to form the channel. A second volume of material in the substrate is exposed to femtosecond laser light, to act as an input waveguide on a first side of the channel. The input waveguide has a first end proximate the channel. A third volume of material in the substrate is exposed to femtosecond laser light, to act as a bar output waveguide on a second side of the channel across the channel from the first side. The bar output waveguide has a first end proximate the channel. A fourth volume of material in the substrate is exposed to femtosecond laser light, to act as a cross output waveguide on the first side of the channel. The cross output waveguide has an end substantially overlapping the first end of the input waveguide proximate the channel. The step of etching the first volume can take place after the second, third and fourth volumes of material are exposed.

Another embodiment of the invention is directed to an optical switch unit that includes a substrate having at least one totally internally reflecting waveguide (TIRW) optical switch. The TIRW optical switch has a channel in the substrate for carrying a liquid, the channel being formed by femtosecond laser-induced chemical etching. An input waveguide in the substrate is on a first side of the channel. The input waveguide has a first end proximate the channel. A bar output waveguide in the substrate is on a second side of the channel across the channel from the first side. The bar output waveguide has a first end proximate the channel and is positioned to receive light from the first and of the input waveguide that is transmitted across the channel. A cross output waveguide is on the first side of the channel, having a first end proximate the channel and positioned to receive light from the input waveguide that is totally internally reflected at a first sidewall of the channel. The bar output waveguide and the cross output waveguide are formed by femtosecond direct waveguide writing.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B schematically illustrate embodiments of an active optical switch networks as may be implemented using the present invention;

FIGS. 2A and 2C schematically illustrate a plan view of an embodiment of a totally internally reflecting waveguide (TIRW) optical switch that may be used in the present invention;

FIGS. 2B and 2D schematically illustrate a cross-sectional view of the TIRW optical switch illustrated in FIGS. 2A and 2C;

FIGS. 3A and 3B schematically illustrate top and side views of a femtosecond laser channel processing step to manufacture a TIRW switch with an open channel according to an embodiment of the present invention;

FIGS. 3C and 3D schematically illustrate top and side views of a channel etching step for manufacturing a TIRW switch according to an embodiment of the present invention;

FIGS. 4A and 4B schematically illustrate top and side views of a femtosecond laser waveguide processing step for manufacturing a TIRW switch according to an embodiment of the present invention;

FIGS. 5A and 5B schematically illustrate top and side views of a femtosecond laser processing step for forming waveguides and exposing a channel region for a TIRW switch, according to an embodiment of the present invention;

FIGS. 5C and 5D schematically illustrate top and side views of a substrate following an etching step to form a channel of a TIRW switch, according to an embodiment of the present invention;

FIG. 6 schematically illustrates a side view of a covering step for manufacturing a TIRW switch with a covered channel, according to an embodiment of the present invention;

FIGS. 7A and 7B schematically illustrate top and side views of an alternate channel laser processing step for manufacturing a TIRW switch with a buried channel according to an embodiment of the present invention;

FIGS. 8A and 8B schematically illustrate top and side views of an alternate channel etching step for manufacturing a TIRW switch with a buried channel according to an embodiment of the present invention;

FIG. 9 schematically illustrates a fluid management system suitable for controlling a TIRW optical switch manufactured according to the present invention;

FIG. 10 illustrates a graph of channel wall surface roughness for various values of laser processing power, laser writing speed and vertical pitch;

FIG. 11 illustrates a section through a channel formed in a fused silica substrate in a manner according to the present invention;

FIG. 12 is a graph showing waveguide propagation loss along a 10 mm waveguide formed in fused silica, as a function of femtosecond laser inscription power for a writing speed of 0.5 mm/s, for writing directions parallel to, and perpendicular to, the linear polarization state of the inscribing laser;

FIG. 13 is a graph showing mode field diameter (MFD) of a 10 mm waveguide formed in fused silica, as a function of femtosecond laser inscription power for a writing speed of 0.5 mm/s, for writing directions parallel to, and perpendicular to, the linear polarization state of the inscribing laser;

FIG. 14 schematically illustrates a TIRW switch in which the input and output waveguides are separated from the channel, according to an embodiment of the present invention;

FIG. 15 shows a measured beam profile for light propagating along a waveguide in an embodiment of TIRW switch fabricated according to the present invention; and

FIG. 16 schematically illustrates an embodiment of a femtosecond laser inscription system that may be used in carrying out the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to systems, devices, and methods that can provide benefits to optical communication networks. More particularly, the invention is directed to active optical switch systems and devices employing waveguide optical switches, such as microfluidically-controlled total-internally reflecting waveguide (TIRW) optical switches. Microfluidically-controlled optical switches have been developed as a type of non-volatile, easily reconfigurable switches that can be configured remotely, which may increase the flexibility of an optical network and help reduce maintenance costs. As the switching state is controlled by microfluidics, the optical switch needs to be powered only at the moment when it needs to be reconfigured. Compared to existing switch concepts, these devices offer very low static power consumption, broadband operation, and high reliability.

Glass-based optical switches offer advantages in that they can be fabricated by femtosecond laser inscription (FLI). Exposing glass, such as fused silica, to tightly focused femtosecond laser pulses results in a permanent modification of the optical and chemical properties of the glass, which are localized in the focal volume of the laser beam. The modification of the optical and chemical properties of the glass can be induced by nonlinear multiphoton absorption processes, hence the reliance on femtosecond pulses. In combination with selectively translating the glass substrate through the focus of a femtosecond laser beam, arbitrary three-dimensional photonic structures or microfluidic channels can be fabricated. The channels are formed by subsequent selective wet chemical etching of the exposed volumes. Femtosecond laser direct waveguide writing (FLDW) and femtosecond laser-induced chemical etching (FLICE) are compatible, as both technologies are based on translating the glass substrate in three dimensions through the laser focus, which allows for simultaneous definition of photonic circuits, as well as fluidic and fiber alignment structures, integrated on a single substrate with sub-micron alignment precision.

Low confinement of light in low refractive index contrast waveguides, such as are generally employed in silica platforms, is favorable for TIR leading to lower reflection losses. Moreover, photonic chips based on low contrast waveguides, such as in silica platforms, are easier to interface with optical fibers and to package than devices manufactured in high index platforms such as silicon. Additionally, the waveguides are symmetrical, and are thus independent of polarization. Besides the advantages silica offers through the use of FLI for fabrication of microfluidics controlled TIR switches, fused silica as a material is advantageous for photonic and microfluidics applications since it is optically clear, stable in time, chemically inert, nonporous, hydrophilic and has a low temperature expansion coefficient. The waveguides formed in a substrate via FLI are done so without doping the substrate to change its refractive index.

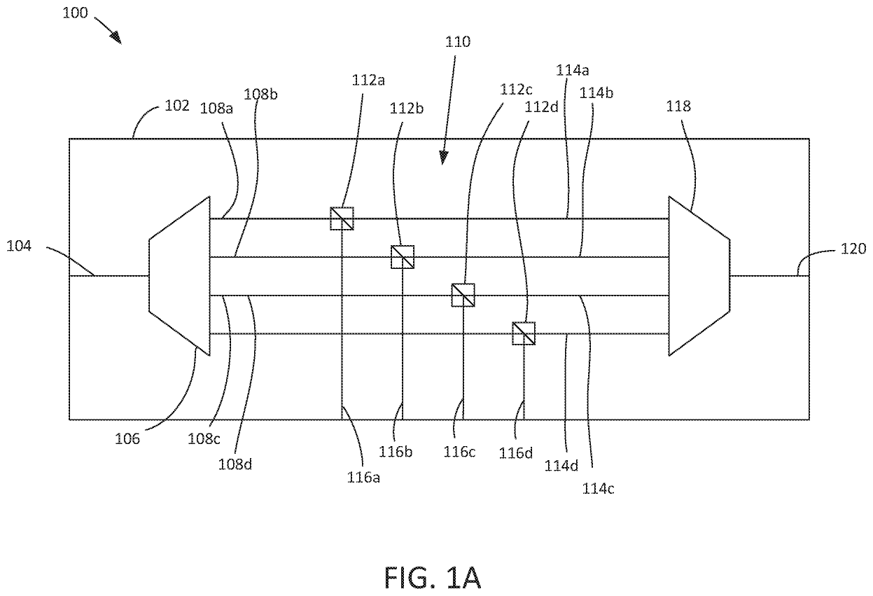

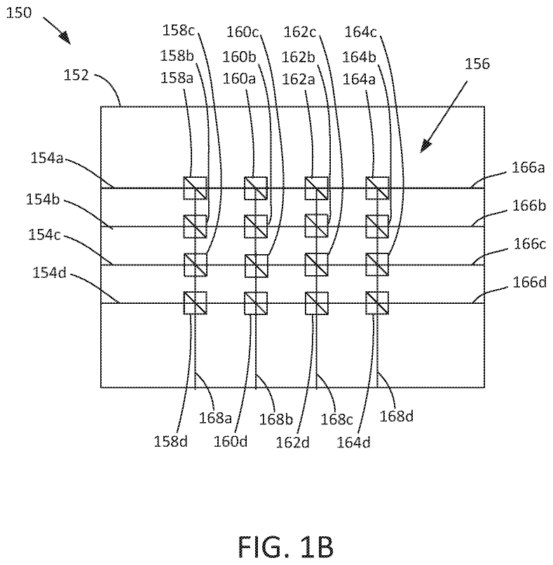

Optical switches can be used in many different kinds of photonic devices. One particular embodiment of an optical chip device 100 that includes non-volatile waveguide optical switches is schematically illustrated in FIG. 1A. The chip device 100 may be formed on a single chip 102 and includes an input waveguide 104 coupled to a demultiplexer 106, such as an arrayed waveguide grating (AWG). The demultiplexer 106 separates a wavelength division multiplexed optical signal received from the input waveguide 104 into its different wavelength components, which are directed along single wavelength waveguides 108a-108d that carry the respective single wavelength components of the WDM optical signal received by the chip device 100. In the illustrated embodiment, the WDM optical signal has four different wavelength components carried by respective single wavelength waveguides 108a-108d, but it will be appreciated that the demultiplexer 106 may split a WDM optical signal into different numbers of components.

The single wavelength waveguides 108a-08b are optically coupled as inputs to an optical switch array 110 that includes waveguide optical switches 112a-112d coupled to receive optical signals along respective waveguides 108a-108d. Each optical switch 112a-112d is operable to direct its incoming optical signal between a respective output waveguide 114a-114d (which may also be referred to as a bar output waveguide), and a respective switched output waveguide 116a-116d (which may be referred to as a cross output waveguide). When in the bar state an optical switch 112a-112d passes the incoming optical signal on to the output waveguide 114a-114d. If, on the other hand, the optical switch 112a-112d is in the cross state, then the incoming optical signal is directed to the respective switched output waveguide 116a-116d. The optical switches 112a-112d may be totally internally reflecting (TIR) waveguide optical switches.

The bar output waveguides 114a-114d may connect to a multiplexer 118, for example a second AWG, that combines the signals, at different wavelengths, propagating along waveguides 114a-114d into a single WDM optical signal that propagates along the output waveguide 120.

The optical chip device 100 may be included within a housing, and be provided with connections via fiber pigtails, e.g. to the input waveguide 104, the output waveguide 120 and one or more of the switched output waveguides 116a-116d. The illustrated embodiment of optical chip device 100 may operate as a programmable add/drop multiplexer, where one or more of the wavelength components of the WDM signal is dropped and directed via the switched output waveguides to a branch network.

Another embodiment of an optical chip device 150 that includes non-volatile waveguide optical switches in an N×N array is schematically illustrated in FIG. 1B. The chip device 150 may be formed on a single substrate 152 and includes input waveguides 154a-154d, which are typically single mode waveguides. The input waveguides 154a-154d are optically coupled as inputs to an N×N optical switch array 156. In the illustrated embodiment, the optical switch array 156 is a 4×4 switch array, but different numbers of switches, input waveguides and output waveguides may be used.

The input waveguide 154a extends across the substrate 152 via a row of optical switches 158a, 160a, 162a, 164a to an unswitched output waveguide 166a. The other input waveguides 154b-154d are likewise connected to respective unswitched output waveguides 166b-166d via a respective row of optical switches. Thus, the input waveguide 154b extends across the substrate 152 via a row of optical switches 158b, 160b, 162b, 164b to unswitched output waveguide 166b. Also, the input waveguide 154c extends across the substrate 152 via a row of optical switches 158c, 160c, 162c, 164c to unswitched output waveguide 166c, and the input waveguide 154d extends across the substrate 152 via a row of optical switches 158d, 160d, 162d, 164d to unswitched output waveguide 166d. Light that enters the device 150 along one of the input waveguides, e.g. 154a, is transmitted along to the unswitched waveguide, e.g. 166a, if all of the switches 158a, 160a, 162a, 164a are in their bar state. However, if one of the switches is in a cross state, then the light is transmitted to the switched output waveguide 168a-168d. For example, if light enters the device 150 along input waveguide 154a and the switch 160a is in the cross state, then the light is diverted to the switched output waveguide 168b. It is often the case, in operation, that one switch along a row is activated, i.e. is in the cross state. Selective activation of different switches permits the signals at the input waveguides 154a-154d to be assigned to different switched output waveguides 168a-168d, depending on which optical switches are activated.

The optical chip device 150 may be included within a housing, and may be provided with connections via fiber pigtails, e.g. to the input waveguides 154a-154d, the unswitched waveguides 166a-166d, and to the switched output waveguides 168a-168d.

While the embodiments just described provide as illustrative examples of an optical chip device that includes microfluidically-controlled optical switches, there is no intention for the invention to be limited to an add/drop filter or N×N switch matrix. Indeed, the intention is to cover any optical chip device that employs the optical switches and their manufacture, as described herein

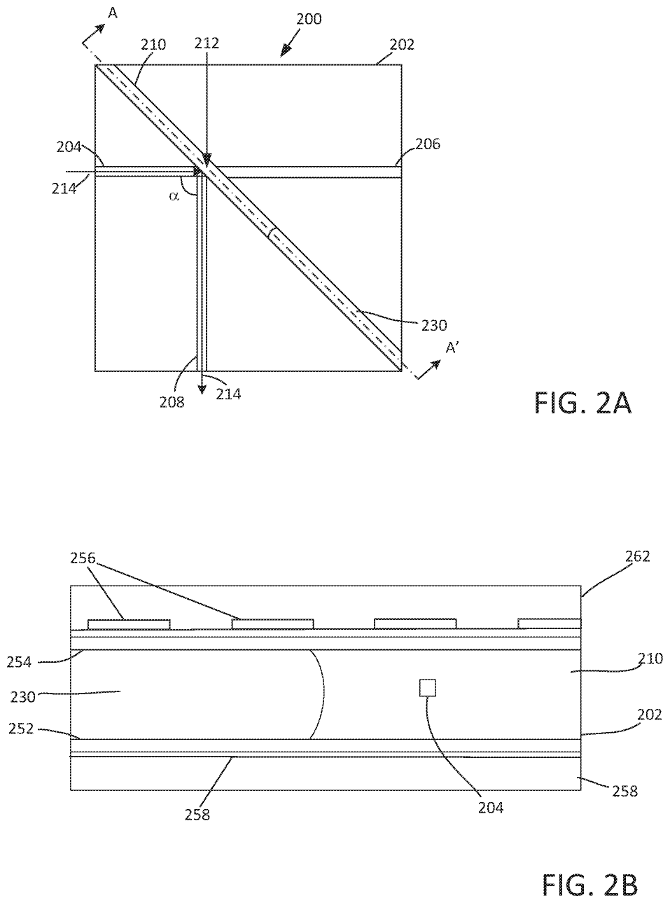

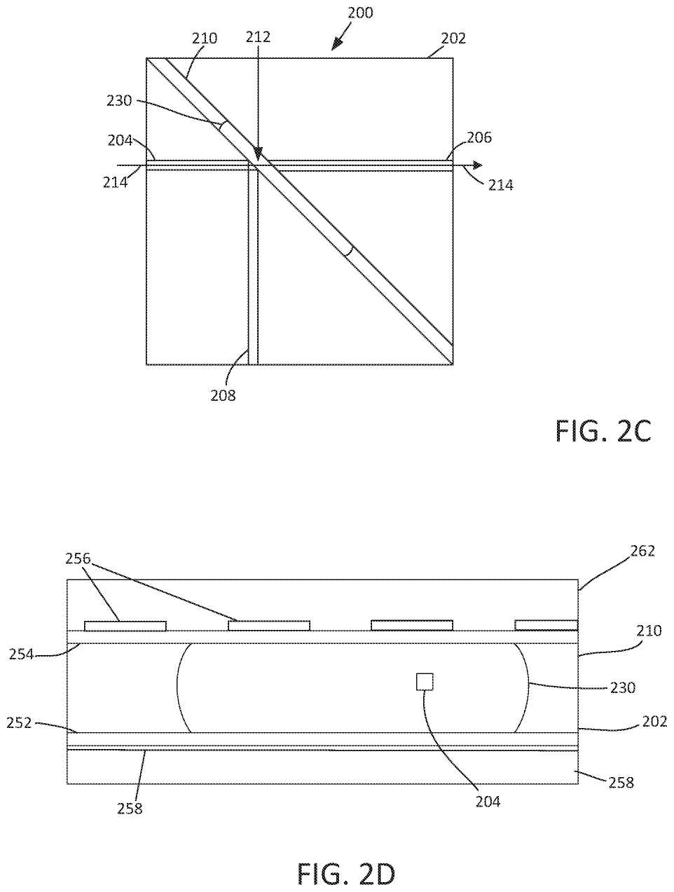

An embodiment of a TIRW optical switch is described with reference to FIGS. 2A-2D. FIG. 2A shows a plan view of an embodiment of a TIRW optical switch 200 in a first, reflective switch state, also known as the cross state. The switch 200 includes a first input waveguide 204, a main output waveguide 206 and a switched output waveguide 208 on a substrate 202. A channel 210 crosses the input waveguide 204 at a crosspoint 212. In many embodiments the channel 210 is mostly filled with air or another gas, such as nitrogen or the like. The bar output waveguide 206 is located across the channel 210 from the input waveguide 204. In the illustrated embodiment, the channel 210 is empty at the crosspoint 212, so light 214 in the input waveguide 204 is total internally reflected at the wall of the channel 210 into the cross output waveguide 208.

A liquid 230 is located within the channel 210. The liquid 230 may be in the form of a droplet or may be in the form of an arm of liquid extending along the channel 210 from a reservoir (not shown). The liquid 230 may be moved along the channel 210 using any suitable type of force, for example via a pressure applied to the liquid. An embodiment of a microfluidic management system that may be used with the TIRW optical switch is described in U.S. Provisional Patent Application No. 62/767,190, incorporated herein by reference. In FIG. 2A, and in FIG. 2B which shows the cross-section AA′ through the switch 200, the liquid 230 does not reach the exit face of the waveguide 204. Therefore, light 214 propagating along the waveguide 204 is totally internally reflected at the channel 210 into the switched output waveguide 208.

Other approaches may be used to move the liquid 230 within the channel 210. For example, the liquid may be moved using an electrowetting-on-dielectric (EWOD) approach, e.g. as described H. D'heer et al, “Non-Volatile Liquid Controlled Adiabatic Silicon Photonics Switch,” J. Light. Technol., (2017) 35 2948-54. In this approach, the liquid may be in the form of a droplet, and its position controlled by selective application of a voltage to different electrodes in the structure. In the illustrated embodiment, the switch 200 is optionally provided with individually addressable electrodes 256 above the channel 210 and a ground plane 258 below the channel 210. In another approach, the liquid may be moved within the channel via the thermal expansion of a gas. These approaches may, however, allow for liquid residues to remain in the channel when it should be empty and cause additional losses in TIR state, especially if the channel sidewalls are not perfectly smooth. Moreover the switching speed is limited to milliseconds. It may be possible, therefore, to use volatile liquids for light transmission through the channel. This approach may reduce the presence of liquid residues remaining on the channel walls and allow for faster switching speeds by properly choosing the liquids with faster evaporation.

The angle, α, between the input waveguide 204 and the switched output waveguide 208 is set primarily by the angle at which the channel 210 intersects the input waveguide 204, using the well-known law of reflection at a planar surface that the angle of reflection is equal to the angle of incidence. The switched output waveguide 208 is preferably oriented for maximum throughput of the light reflected at the wall of the channel 210 at the angle of reflection set by the angle of incidence of the input waveguide 204 on the channel 210. In the illustrated embodiment, the channel 210 intersects the input waveguide 204 at an angle of 45°, and so the angle α is set at 90°. However, the value of α is preferably chosen to be a value that results in reduced switch insertion loss, and so the channel 210 may intersect the input waveguide 204 at a different angle, for example a greater angle, in which case the value of a is greater than 90°.

The cross-sectional view of FIG. 2B schematically illustrates the layers that may be used in forming this embodiment of TIR waveguide optical switch. The channel 210 is formed in a substrate 258 which may be, for example, silica. The waveguide 204, formed in the substrate 258, is shown with a square cross-section, but this is not a requirement and the waveguide 204 may have any suitable cross-sectional shape including, for example, circular, elliptical or rectangular. A cover layer 262 may be provided over the channel 210 so as to seal the channel 210, which can reduce the possibility of contaminants entering the channel 210. In some embodiments, the channel 210 may be etched as a buried channel, in which case the cover layer 262 may be formed integrally with the substrate 202. In other embodiments, the channel 210 is formed as an open channel in the surface of the substrate, and the cover layer 262 applied over the channel 210 and sealed. The walls and floor of the channel 210 may be provided with an anti-wetting coating, for example a monolayer of a fluorinated alkyl silane as discussed in U.S. Provisional Patent Application No. 62/393,473, incorporated herein by reference. The figure shows an anti-wetting layer 252 on the floor of the channel 210. The cover 262 may also be provided with an anti-wetting layer 254.

The refractive index of the liquid 230 is selected so that, when the liquid 230 is positioned at the crosspoint 212, light 214 propagating along the first waveguide 204 is incident on the wall of the channel 210 at an angle that does not result in total internal reflection at the wall of the channel 210 but is, instead, transmitted across the channel to the bar waveguide 206, as is schematically illustrated in FIGS. 2C and 2D. Thus, a TIRW optical switch can be in either of two states, a reflective state, also referred to as the cross state, or a transmissive state, also referred to as the bar state, depending on whether the liquid droplet 230 is present at the crosspoint between the input waveguide 204 and the fluid channel 210. A plan view of the switch 200 in the bar state is shown in FIG. 2C. FIG. 2D shows a cross-sectional view of the switch configuration after the liquid droplet 230 has been moved to the crosspoint 212, thus preventing total internal reflection from taking place.

As discussed above, the approach employed here for manufacturing the TIRW switches and waveguides is FLI, including FLICE for manufacturing the microfluidic channels and FLDW for manufacturing the light confinement structures. The switch's channel and waveguides can be well aligned to each other since they can be defined in the same laser exposure. Potassium hydroxide (KOH) is generally chosen for the chemical etching due to its high selectively towards the irradiated volume, as compared to the unirradiated surrounding material, although other etchants may be used. This enables fabrication of channels with controlled width and vertical walls necessary for good angular alignment between the waveguides and the TIR mirror. FLI can achieve lower sidewall roughness, and better sidewall verticality, than can be typically be achieved using standard techniques such as reactive ion etching (RIE).

In an example using fused silica, the refractive index of a fused silica glass substrate nₛ is 1.444 at a wavelength λ=1550 nm. The measured refractive index (RI) change induced in silica by femtosecond laser pulses is ˜5×10⁻³ in this work, as is discussed below. Since the RI change is low, the effective index of the mode can be approximated with the index of unmodified fused silica glass. In order to achieve the TIR of infinite plane waves at fused silica-air interface, light should be incident at the interface at an angle greater than the critical angle, α_{c}, where α_{c}=arcsin (1/nₛ). In silica α_{c}=43°. However, light in the single mode waveguides propagates as a mode with a finite width and an approximately Gaussian field distribution. Therefore, when the waveguide mode is incident at the fused silica/air interface, it is not incident under a single angle but under a range of angles defined by the numerical aperture of the waveguide. In order to reduce losses when the switch is in its cross (TIR) state, this spread of incident angles is taken into account and the angle between the input waveguide and the channel is preferably selected so that the TIR condition is satisfied for the whole range of incident angles. The waveguide dimensions may be chosen in such way as to ensure single mode operation of the waveguides. In general, the angle, α, between the input waveguide and the switched output waveguide is preferably larger than about 96°.

The light propagates without confinement across the channel when the switch is in its bar state. Therefore, the channel is preferably relatively narrow and the refractive index of liquid in the channel preferably matches, or closely matches, the refractive index of fused silica to reduce optical losses when the switch is in is bar (transmissive) state. The size of the channel width is generally limited by the processing steps used for manufacturing the channel. FLI provides the possibility of reducing the width below about 20 μm. However, as the channel width reduces, the amount of light coupled to the switched output waveguide increases, which can lead to crosstalk between the main and switched output waveguides. Therefore, one of the goals of switch design is to reduce bar-state insertion loss while also maintaining cross-talk at an acceptably low level. Furthermore, cross-state losses can increase as the channel width is reduced, due to evanescent coupling across the channel arising from the close proximity of the second channel wall. Therefore, in general, it is preferred that the channel width is greater than about 5 μm and less than about 30 μm.

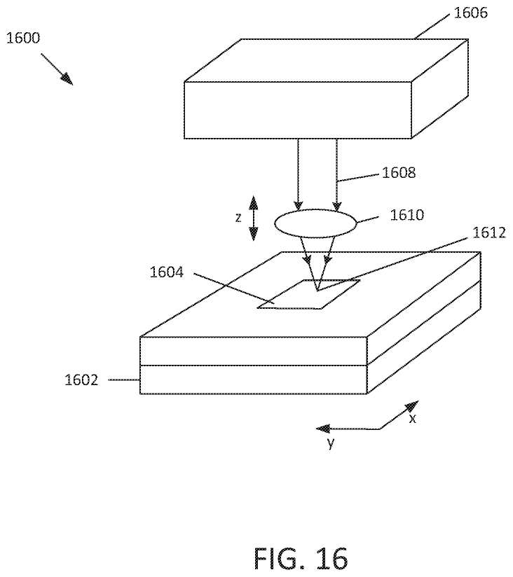

An illustration of a simple femtosecond laser inscribing system 1600 that may be used to make TIRW switches as described herein is discussed with reference to FIG. 16.

The system 1600 includes a translation stage 1602 on which a substrate 1604 can be mounted. In the illustrated embodiment, the translation stage provides translation in two dimensions, the x- and the y-directions.

A femtosecond laser 1606 produces a femtosecond laser beam 1608 that is focused by a focusing system 1610 to the substrate 1604. The focusing system 1610 may include one or more lenses, mirrors or other types of focusing elements, or a combination of the same. In the illustrated embodiment, the position of the focusing system 1610 is movable in the z-direction, which permits adjustment of the depth of the focus 1612 of the femtosecond laser beam 1608 within the substrate 1604.

The femtosecond laser beam may be delivered to the focusing system via any suitable means, for example via free space propagation or via an optical fiber. Also, the depth of the focus within the substrate 1604 may be adjusted by providing a z-direction adjustment on the translation stage 1602, rather than by moving the focusing element 1610. In another embodiment, an optical beam delivery system, that transmits the laser beam 1608 from the femtosecond 1606 to the substrate 1604, may be adjustable to provide movement of the laser focus in the x-, y-, and z-dimensions, instead of using the translation state 1602.

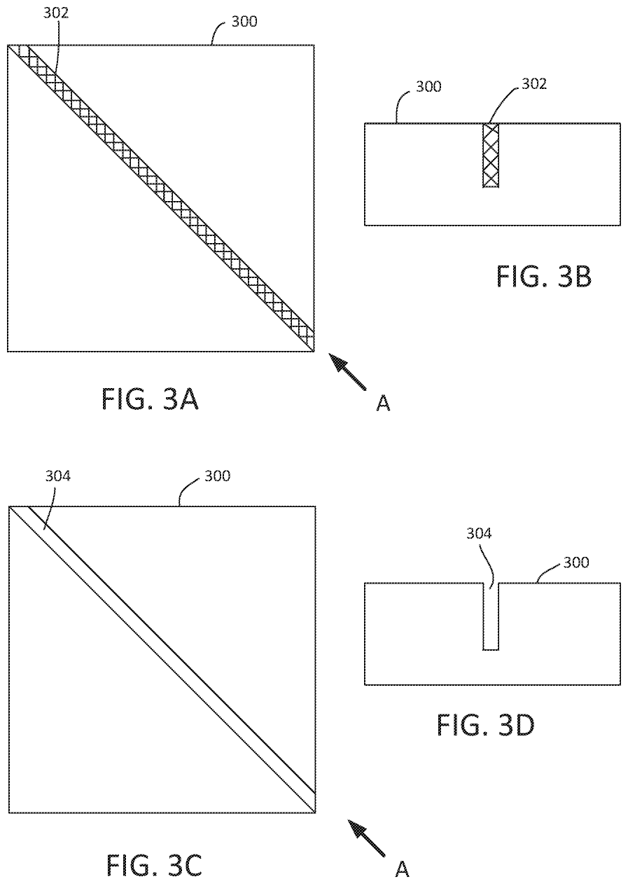

An approach to forming channels using FLICE in silica is now described with reference to FIGS. 3A-3D. FIG. 3A schematically illustrates a plan view of a portion of a substrate 300. A region (shown as a hatched region) 302 is exposed to femtosecond laser light via a 3-D writing process that comprises multiple passes of the laser focus through the substrate 300 using, for example, an x-y-z stage to move the substrate relative to the laser focus. In other embodiments, the substrate 300 may be mounted on an x-y translation state and the depth of the laser focus into the substrate 300 adjusted by translating the focusing lens in the z-direction. Typical exposure conditions are discussed in greater detail below. FIG. 3B shows a side view looking along the exposed (hatched) region 302, in the direction marked by the arrow “A.” In order to avoid problems that may arise from writing through a volume of glass that has already been laser-processed, it is preferable to start the processing at the greatest depth of the desired feature and to process in layers up towards the upper surface of the substrate 300.

The exposed region 302 can then be removed via etching, for example with HF or KOH, resulting in the formation of the channel 304. Typical etching conditions are discussed in greater detail below. FIG. 3C shows a plan view of the substrate 300 after etching, while FIG. 3D shows a side view along the direction marked by the arrow “A.” The channel 304 may be referred to as an open channel, as it is open to the upper surface of the substrate 300.

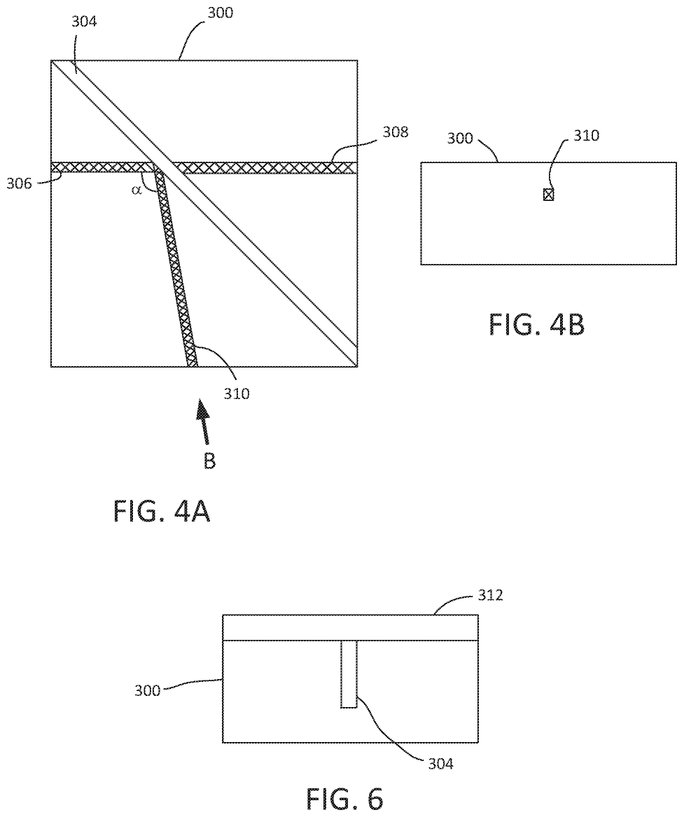

FIG. 4A schematically illustrates a plan view of waveguides formed in the substrate 300 around the channel 304. The input waveguide 306, bar output waveguide 308 and cross output waveguide 310 are all formed in the substrate 300 by exposing the desired volume of the substrate to the femtosecond laser radiation. The exposure conditions to form the waveguides 306, 308, 310 in the substrate are discussed in greater detail below. FIG. 4B schematically illustrates a side view of the substrate 300, looking along the direction marked with the arrow “B.” In the illustrated embodiment, the angle a between the waveguides 306, 310, is greater than 90°.

One advantage of the process discussed with regard to FIGS. 3 and 4 is that, when the etching step is performed before processing the waveguides, the etchant does not etch the processed waveguide volumes of material. On the other hand, unless the substrate is etched in situ on the x-y translation stage, this approach requires realigning the substrate on the x-y translation stage before writing the waveguides. The order of the processing and etching steps may be different. For example, the etching step may be performed after the channel and waveguides are processed by the femtosecond laser, in which case there is no need for realignment of the substrate between writing the channel and the waveguides. On the other hand, care needs to be taken to avoid etching the waveguides. One approach to avoid etching the waveguides is to stop the waveguides a few microns from the channel wall.

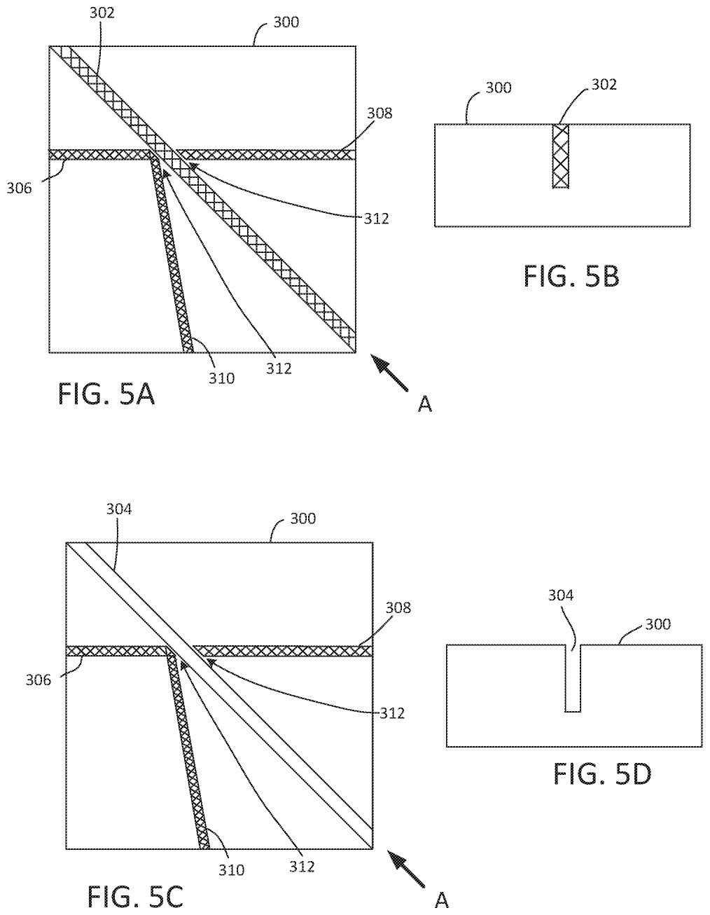

This different order of processing steps is illustrated in FIGS. 5A-5D. The volume 302 that is to be etched to form the channel, and the waveguides 306. 308, 310 (shown as hatched areas) are written in the substrate 300, as shown in FIGS. 5A and 5B. The substrate 300 is then exposed to the etchant, and rinsed, to form the channel 304 in the upper surface of the substrate. 300. In this embodiment, there may be small gaps 312 between the ends of the waveguides 306, 308, 310 and the sidewall of the channel 304 of a few microns to prevent the waveguides from being etched. Gaps 312 are preferably more than one micron and more preferably around 3 μm.

An optional cover 312 may be placed over the open channel 304 in order to prevent the ingress of dirt, dust, and other foreign matter into the channel 304, and also to maintain the liquid in the channel 304, as shown in FIG. 6. The cover 312 may be made from the same material as the substrate 300, although this is not a requirement, and it may be made from another material. The cover may be attached and sealed onto the substrate using any suitable means, such as an optical adhesive. As described above, the portion of the cover 312 exposed to the liquid in the channel may be provided with an anti-wetting coating.

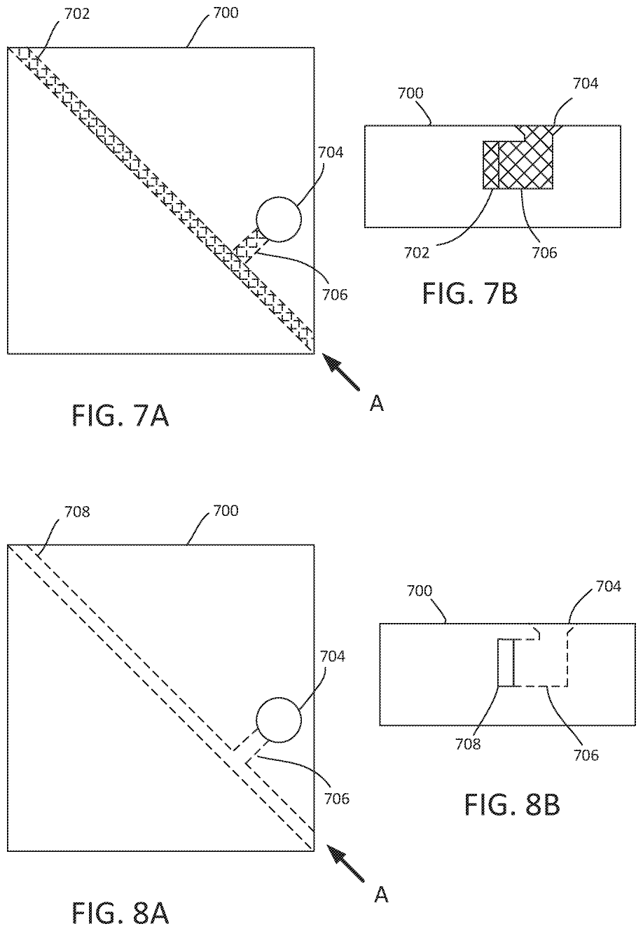

Instead of using a cover to seal the channel, an alternative approach is to form a buried channel. This approach is now described with reference to FIGS. 7 and 8. FIG. 7A schematically illustrates a plan view of a portion of a substrate 700. A channel region 702 is exposed to femtosecond laser light via a 3-D writing process that comprises multiple passes of the laser focus through the substrate 300 using, for example, an x-y-z stage to move the substrate relative to the laser focus. The exposed channel region 702 is that volume of material which it is desired to remove in order to form the channel. In this embodiment, the exposed region 702 does not reach the surface, hence it is shown drawn with dashed lines. In order to permit the etchant to access the exposed region 702, a port 704 is defined by laser exposure, along with a path 706 from the port to the exposed region 702. FIG. 7B shows a side view looking along the exposed region 702, in the direction marked by the arrow “A.”, the view also shows the port 704 and the path 706.

The port 704, path 706 and exposed region 702 can then be removed via etching via the port, resulting in the formation of the channel 708. FIG. 8A shows a plan view of the substrate 300 after etching, while FIG. 8B shows a side view along the direction marked by the arrow “A.” The channel 708 may be referred to as a buried channel, as it is buried below the upper surface of the substrate 700. The waveguides leading to and from the channel 708 may subsequently be formed in the substrate 700 using the same process as outlined above with reference to FIGS. 5A and 5B.

While the embodiments of FIGS. 3-5 and 7-8 show the formation of the channel before the formation of the waveguides, this need not necessarily be the case, and the waveguides may be formed before the channel. However, in order to reduce the possibility that the waveguides will be etched during the etching step, it may be preferable to etch the channel prior to forming its associated waveguides.

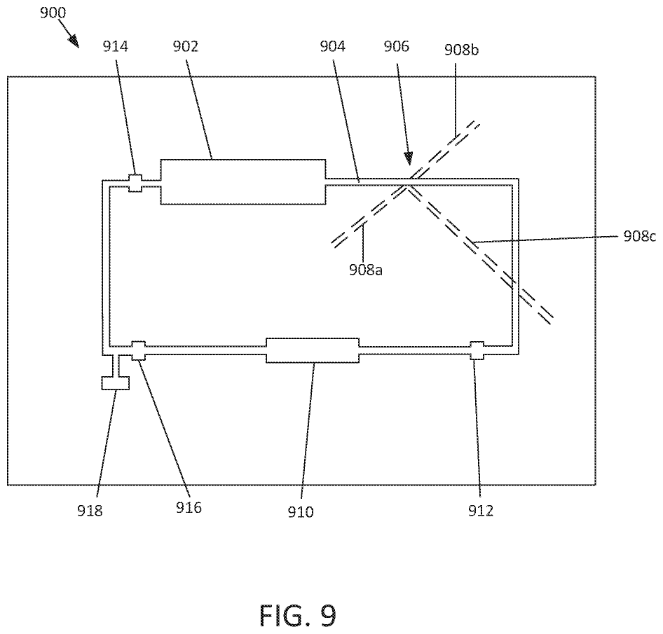

One embodiment of a system that may be used for controlling the flow of liquid in a TWIR optical switch is the microfluidic management system schematically illustrated in FIG. 9. Further details of the fluid management system 900 are to be found in 62/767,190, incorporated herein by reference. The fluid management system 900 is formed in a separate layer from the optical switch layer. There is, however, communication between the fluid management system and the optical waveguide substrate in the region of the WTIR switch, so that liquid can pass from the liquid management system 900 into the switch channel and thus activate the switch.

The fluid management system 900 includes a liquid reservoir 902 coupled by a channel 904 to the switch region 906 where the switch channel and waveguides 908a, 908b, 908c (shown in dashed lines) are located. One side of a pump 910 is connected to the switch region 906 via a first valve 912 and to the reservoir 902 via a second valve 914 and a third valve 916. An exhaust valve 918 is located between the second and third valves 914, 916. The fluid management system 900 will also include a fluid filling port (not shown).

One way of operating the fluid management system 900 is now described, with the starting assumptions that it has received a fill of liquid, which is located in the reservoir 902, and that there is initially no liquid at the switch region 906. With the second and third valves 914, 916 open, the pump 910 increases pressure on the left side of the reservoir 902, forcing some liquid along the channel to the switch region 906, thus activating the switch. Pressures can then be equilibrated across the reservoir 902 and switch region 906 by sequential release of pressure through the exhaust valve 918 from each side of the reservoir by selective activation of the valves 912, 914, 916. This leaves the TWIR optical switch in a non-volatile bar state. To remove liquid from the TWIR switch, the first and second valves 912, 914 are opened, and the pump 910 increases pressure on the right side of the reservoir 902, forcing the liquid from the switch region 906 back to the reservoir 902. Thus, the state of the switch is changed to the cross state. Again, pressures on both sides of the reservoir 902 can then be equilibrated by selective control of the valves 912, 914, 916 and the exhaust valve 918.

If the RI of the liquid, nₗ, is not exactly matched to the RI of the input waveguide, n_{w}, the position of the bar output waveguide may be laterally translated to compensate for the refraction-induced lateral shift of the optical beam that occurs on crossing the channel. However, as the RI mismatch increases, the isolation of the switched output waveguide will worsen due to Fresnel reflection at the interface between the waveguide and the channel. It is preferred, therefore, that the index mismatch, Δn (=|n_{w}−nₗ) between the waveguide and the liquid is less than about 0.05, preferably less than 0.01 and more preferably less than 0.005.

### EXPERIMENTAL RESULTS

### Experiment 1: Femtosecond Laser Inscribing Fabrication Techniques

An ytterbium-doped fiber laser (Satsuma model, available from Amplitude Systèmes, Pessac, France) was used to fabricate both microfluidic channels and high quality optical waveguides, integrated together on a single glass substrate. The output from the laser was frequency doubled to produce a wavelength of 515 nm in order to achieve more efficient laser processing of wide-bandgap fused silica by reducing the order of the multiphoton absorption process. The pulse length was <400 fs and the repetition rate was 500 kHz. The linearly polarized laser beam was focused using a 0.6 NA aspheric lens (Newport 5722-A-H). The average power of the beam from the laser was controlled, using an automated rotatable ½-wave plate/linear polarizer combination, to range between about 25 mW-350 mW, measured after focusing.

The glass samples used in the experiments described below were high purity 500 μm thick fused silica substrates obtained from Siegert Wafer GmbH, Aachen, Germany. The samples were placed on a computer-controlled motorized XY stage which could be translated perpendicularly to the laser beam with a speed ranging from 0.01-10 mm/s. The focusing lens was translatable along the axis of the femtosecond laser beam.

### Experiment 2: Microfluidic Structure Fabrication and Characterization

Microstructures can be fabricated in fused silica by femtosecond laser-assisted chemical etching of irradiated volumes in fused silica glass. The volumes exposed to femtosecond laser radiation have higher etch rate than unexposed glass and can be selectively removed in the subsequent wet etching step in aqueous solutions of potassium hydroxide (KOH) or hydrofluoric acid (HF). An etching selectivity of the order of 1:50 can be typically achieved in fused silica when using diluted HF acid as the etchant. Thus, when the depth of the surface microfluidic channel is increased, the channel will become significantly wider near the opening area, which leads to a tapered structure and sidewall angle which could cause significant losses in the reflection state of the switch. The use of KOH rather than HF has been found to produce a significantly improved selectivity between the exposed and unexposed regions, which allows for fabrication of high-aspect-ratio microfluidic channels with controllable and uniform width.

The femtosecond laser-induced etch rate in fused silica is dependent on the polarization of the writing beam. It is believed that the mechanism behind this phenomenon is the formation of periodic nanograting-like structures in regions irradiated with linearly polarized femtosecond laser pulses, which are intrinsically oriented perpendicular to the polarization of the writing laser beam. Therefore, the polarization of the incident laser light was set to be perpendicular to the direction of sample translation in order to benefit from the enhanced etching selectivity due to better penetration of etchant in the laser-exposed regions.

A multi-scan technique is used to expose the channel volume that is to be etched to form the channel. The microfluidic channel can be formed as a buried channel or as a surface channel, i.e., a channel that is open to the surface of the substrate. Typically, the verticality of the sidewalls of a surface channel is more controllable compared to that of buried channels. Also, the total etching time for a surface channel is shorter than for a buried channel, since the etchant can more easily access the irradiated volume. Therefore, the initial work reported here focuses on optimizing the fabrication of rectangular surface channels. The multi-scan technique relies on making a matrix of laser track lines with a certain separation along channel width and height. It has been suggested that the presence of internal stress surrounding the laser track lines is the main raison for the induced acceleration in etching rate of the exposed glass. Therefore, the presence of adjacent multiple tracks can affect the etching process since the stress field and the material densification in the region of the previously written tracks can be perturbed by subsequently written tracks.

The presence of the air/glass interface in the laser beam path introduces an aberration distorting the wave front of the converging spherical wave and may cause spreading of the intensity distribution along the beam propagation direction near the focus. This may lead to depth-dependent variation of the threshold pulse energy for femtosecond laser induced material modification.

Before applying the multi-scan technique to fabricating a surface channel, a detailed study was performed to examine the influence of laser power and translation speed of the stage on the roughness of the channel sidewall after etching. This was done by making a single stack of laser tracks going through the 500 μm thick fused silica samples. Lines of exposed material were formed, stacked on top of each other from the bottom of the substrate to the top of the substrate to avoid light scattering at already modified tracks. The separation between lines was 1 μm and 2 μm. The exposed glass was etched for 4 hours in 30% aqueous KOH solution held at 85° C. Magnetic stirring was to maintain a uniform temperature distribution. The substrate was then washed using distilled water. After etching was completed, the sidewall roughness was characterized using a white light interferometry technique.

The motorized stage carrying the substrate was translated at speeds ranging from 1-10 mm/s and the average laser power was increased from 25-250 mW. It was found for all translation speeds that the power threshold for etching is 50 mW. It was also found that increasing the power further did not render significant changes in the average roughness of the resulting sidewall, but could lead to the emergence of micro-explosion sites which can locally deteriorate the surface optical quality.

FIG. 10 presents graphical results of measured sidewall rms surface roughness (nm) for various average optical inscribing powers, scanning speeds and z-step size. Six results are presented for four levels of average power, corresponding to different writing speeds and vertical steps (in the z-direction). The writing speeds tested were 1 mm/s, 5 mm/s and 10 mm/s, and the vertical step sized tested were 1 μm and 2 μm. Accordingly, each group of six results shows, from left to right, the following combinations of writing speed and step size: i) 1 mm/s and 1 μm; ii) 1 mm/s and 2 μm; iii) 5 mm/s and 1 μm; iv) 5 mm/s and 2 μm; v) 10 mm/s and 1 μm; vi) 10 mm/s and 2 μm. Three results are shown with an average power of 250 mW, for the conditions of: i) 1 mm/s and 1 μm; ii) 1 mm/s and 2 μm; iii) 5 mm/s and 1 μm. The lowest rms roughness rms is below 50 nm for the lowest stage translation speed of 1 mm/s. Average roughness tends to increase with writing power. This surface roughness, less than 100 nm rms, and preferably less than 50 nm rms, is better than can be achieved using conventional techniques, such as RIE.

Next, multi-scan exposure and channel formation steps were taken using the parameters that gave the lowest roughness, i.e. a laser power 50 mW and translation speed 1 mm/s, for the multi-scan exposure and rectangular channel formation. This selected translation speed is less than 3 mm/s. The depth of the channel was conditioned with the minimal depth at which the low loss waveguides can be inscribed as well as with the maximal depth at which the spherical aberrations from air/fused silica interface do not significantly disturb the intensity distribution in the laser focus spot. The channel is preferably more than 100 μm deep because waveguides have to be more than 40 μm below the surface of fused silica sample to achieve higher RI difference and MFD around 10 μm. The channel width was set at 20 μm.

Similarly to vertical single line stacking, the horizontal layers were exposed from bottom to top in order to avoid scattering of laser beam when passing through the already modified glass regions. It was found that track-to-track separations in horizontal and vertical direction dy=dz=2 μm is sufficient to avoid deterioration of sidewall surface roughness after etching compared to vertically stacked single line laser tracks. The surface roughness below rms 50 nm, which is less than 100 nm, was measured with an interferometer after dicing the channel through to expose the walls. Since the extent of the modified volume in glass after a single laser line exposure leads to a certain width of etched pattern, we tested the necessary number of lines in the horizontal direction to obtain 20 μm wide channels for the chosen irradiation conditions. It was found that 8 tracks with the separation of 2 μm are sufficient are sufficient to produce a channel 20 μm wide. Therefore, the matrix of 8×70 laser modification tracks, i.e. 8 tracks in the y-direction and 70 in the z-direction, was formed in order to fabricate a channel having cross-section dimensions 20 μm×140 μm. The channels were 5 mm in length.

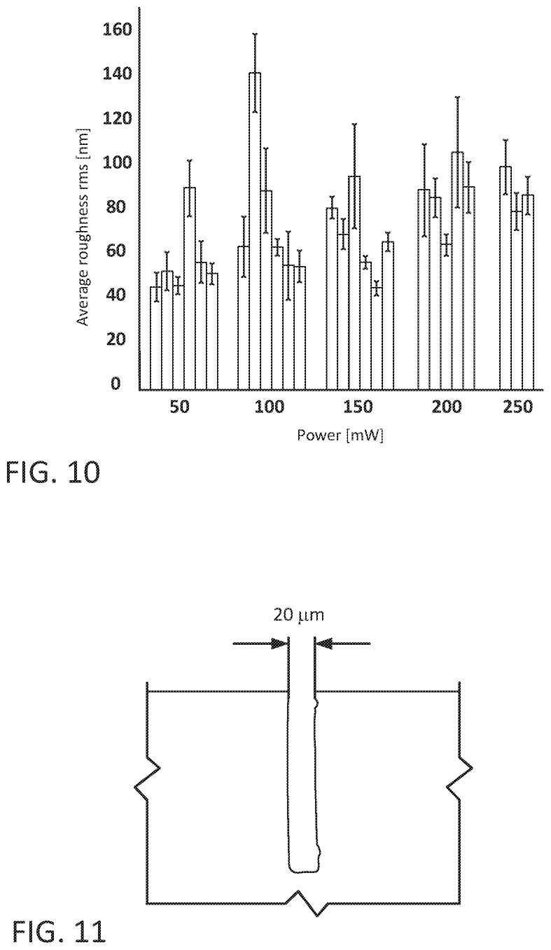

An evaluation of the channel cross-section showed that the sidewall angle of the fabricated channel is less than 1 °, see FIG. 11. The cross-section of the channel was exposed after dicing the sample in a direction perpendicular to the channel. The shape of the cross-section was examined after being polished to a high optical quality after encapsulation in a polymer which provides mechanical stability and prevents glass breaking off the edges during polishing. KOH etching and its high selectivity towards laser irradiated fused silica is preferred for obtaining channels with controllable width and minimal sidewall channel angle. This sidewall angle is better than can be achieved with conventional etching methods, such as RIE.

Liquid reservoirs may be added to enhance the etchant flow into the channel region and to be used for easier filling of the channel with liquid. Adding the reservoirs enables etching of several mm long channels.

### Experiment 3: Waveguide Fabrication and Characterization

A detailed optimization of the waveguide inscription process was performed. FLI parameters such as laser pulse energy and stage translation speed were varied in order to find the parameter processing window for single mode waveguides at telecom wavelengths with the optimized characteristics of low propagation loss and mode profiles similar to mode profile of single mode fibers to ensure low coupling losses.

The waveguide mode profiles of the fabricated waveguides were recorded by imaging the near field output from the waveguide using an infrared camera coupled to a 100X infinity-corrected objective after launching the light from a fiber-coupled laser diode operating at 1550 nm to the waveguides through a single mode fiber (SW-28). The mode field intensity profiles of single mode fiber at 1550 nm were measured using the same technique as a reference to compare with the modes of the waveguides. The mode field diameters from the recorded mode intensity distributions were calculated using a 1/e² method.

Propagation losses of the waveguides were obtained from the slopes of the optical frequency domain (OFDR) measurements of the waveguides. OFDR measurements were performed by launching the light into the waveguides using the single mode fiber connected to a tunable laser source incorporated in the commercial OFDR device (OVA 5000, supplied by Luna Inc., Roanoke, Va.) and using the provided software. Waveguides 10 cm long were fabricated for the OFDR measurements and RI matching liquid was applied between input fiber and waveguide sample in order to minimize the reflections at the input. The coupling losses were obtained by subtracting the propagation loss contribution from total insertion loss measurement of the waveguides.

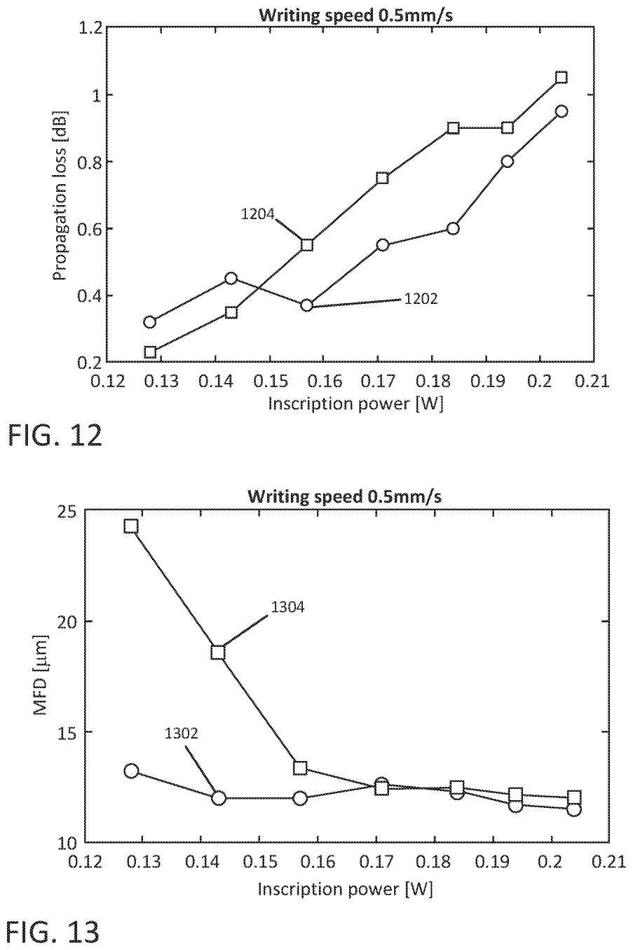

Similarly to the femtosecond laser-induced chemical etching of fused silica, the polarization of the incident femtosecond laser light was found to influence the properties of the resulting waveguides. To examine this effect, waveguides were written both parallel, and perpendicular, to the polarization of the femtosecond laser over ranges of pulse energy and stage translation speed. Measurements of the resulting waveguides showed that the lowest loss single mode waveguides for both laser scanning orientations were obtained for a writing speed of 0.5 mm/s. As expected, lower loss waveguides are obtained when they are inscribed in a direction parallel to the laser polarization, except for inscription at the lowest powers. FIG. 12 shows the propagation loss along the 10 cm waveguide as a function of inscription power, for writing directions both parallel, curve 1202, and perpendicular, curve 1204, to the laser polarization. A propagation loss below 1 dB/cm can be obtained for a broad range of femtosecond laser power for both waveguide writing orientations.

It was observed that, in addition to reducing the waveguide propagation loss, decreasing the inscription pulse energy also results in a larger mode field diameter (MFD) of the waveguide modes. FIG. 13 shows a graph of MFD as a function of inscription power, for inscription direction parallel, curve 1302, and perpendicular, curve 1304, to the polarization of the inscribing light. It was determined to use a laser power of 155 mW for inscribing the waveguides, as this power provides not only low propagation loss, but also results in a waveguide mode field diameter that closely matches that of SMF-28 fiber, thus reducing coupling losses. This average power level is between 2-4 times the average power level used to process the channel volume before etching, and is around 3 times the average power. The relatively small difference in waveguide characteristics written with two different orientations of polarization suggests that the laser polarization is not as critical a parameter for waveguide inscription as it is for FLICE. The waveguides described below were written using a polarization perpendicular to the direction of writing.

### Experiment 4: Integrated Fabrication of Waveguides and Microfluidic Channels

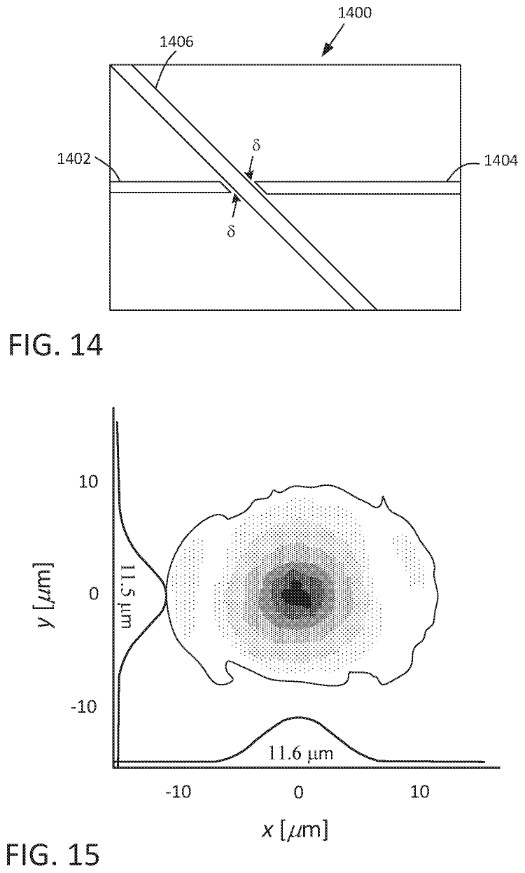

Since the fabrication of both microfluidic channels and waveguides relies on the localized modification of fused silica exposed to the femtosecond laser beam, the integration of both types of structures is preferably performed in an optimal way to reduce the possibilities of either etching the waveguides along with the microfluidic channel or damaging the channel walls. One approach to solving this problem is to stop waveguide writing before reaching the channel. To test this proposition, ten different TIRW structures were formed, with the input and bar output waveguides terminating close to a channel. The test geometry is schematically illustrated in FIG. 14, which shows a substrate 1400, with an input waveguide 1402, a bar state waveguide 1404 and a channel 1406. The separation, 6, between the ends of the written waveguides 1042, 1404 and the walls of the channel 1406 was varied between 0 μm and 10 μm. It was found that waveguides 1402, 1404 that terminated at least 3 μm away from the channel were not etched together with the channel 1406.

### Experiment 5: Characterization of Optical Switch

A TIRW switch was fabricated, with input, main output and switched output waveguides each 1.7 mm in length. The waveguide length was selected to facilitate the measurements. In practice, the TIRW switch may be provided with shorter waveguides.

The angle between the input waveguide and the cross output waveguide was 116°. The fabricated waveguides were single mode, with the light propagating therethrough having a nearly circular diameter of 11.5 μm at 1550 nm. FIG. 15 shows the measured circular beam profile produced by the waveguides, which allows for low loss coupling to and from single mode optical fibers. The measured coupling loss between an SMF-28 fiber and waveguide was less than 1.5 dB without RI matching fluid and 1.1 dB with RI matching liquid between the input and output fibers and waveguides. The propagation loss in the waveguide at 1550 nm was polarization independent and below 0.5 dB/cm.

This optical switch was experimentally characterized using a laser light source operating at wavelength of 1550 nm and an optical power meter (Model 1930-C obtainable from Newport Corp., Irvine, Calif.) to detect the power at the two outputs, bar and crossed. Single mode optical fibers at 1550 nm (SMF-28) were used to in- and out-couple power from the switch waveguides. Fiber to fiber transmission was measured as a reference for insertion loss of the WTIR switch. Index matching liquid (n_{D}=1.46, series AA liquid, obtainable from Cargille Labs, Cedar Grove, N.J.) was applied between fibers for the reference measurement and fibers and waveguides for the insertion loss measurements.

The cross state was characterized first with air in the channel. An insertion loss of 4.93 dB was measured by positioning the input and output fibers under a mutual angle and in line with input and cross waveguides. Propagation loss contribution and coupling loss between fibers and waveguides with RI matching liquid applied is subtracted from the insertion loss in order to calculate loss due to the total internal reflection at the channel wall. The reflection loss was calculated to be 1.5 dB.

The bar state was characterized after filling the channel with RI matched liquid. The measured insertion loss was 4.28 dB. This loss was compared to the insertion loss of a waveguide written on the same glass sample with the same length as sum of input and bar waveguides and under the same angle but which did not intersect the channel. The insertion loss of the reference waveguide was 3.78 dB indicating that the excess loss due to the transmission through the channel was 0.5 dB. The same value for the transmission loss was obtained after subtracting the waveguide propagation loss and the coupling losses between the fibers and waveguides from the insertion loss in the bar state of the switch.

Various modifications, equivalent processes, as well as numerous structures to which the present invention may be applicable will be readily apparent to those of skill in the art to which the present invention is directed upon review of the present specification. The claims are intended to cover such modifications and devices.

As noted above, the present invention is applicable to optical communication and data transmission systems, including active optical switch systems. Accordingly, the present invention should not be considered limited to the particular examples described above, but rather should be understood to cover all aspects of the invention as fairly set out in the attached claims.

What we claim as the invention is:

1. A method of forming an optical switch, comprising:
exposing a first volume of material in a substrate to femtosecond laser light, the first volume selected to act as a channel in the optical switch;
etching the exposed first volume in the substrate to form the channel;
exposing a second volume of material in the substrate to femtosecond laser light, the second volume selected as an input waveguide on a first side of the channel, the input waveguide having a first end proximate the channel;
exposing a third volume of material in the substrate to femtosecond laser light, the third volume selected as a bar output waveguide on a second side of the channel across the channel from the first side, the bar output waveguide having a first end proximate the channel;
exposing a fourth volume of material in the substrate to femtosecond laser light, the fourth volume selected as a cross output waveguide on the first side of the channel, the cross output waveguide having an end substantially overlapping the first end of the input waveguide proximate the channel.

2. The method as recited in claim 1, wherein the liquid channel is an open channel, and wherein exposing the first volume of material comprises exposing the first volume up to an upper surface of the substrate.

3. The method as recited in claim 2, further comprising covering the open channel with a cover.

4. The method as recited in claim 1, wherein the liquid channel is a buried channel.

5. The method as recited in claim 4, further comprising exposing a fifth volume of material as a port on an upper surface of the substrate and a sixth volume of material as a liquid path within the substrate, the fifth volume adjacent and in communication with the sixth volume and the sixth volume adjacent and in communication with the first volume, and further comprising etching the exposed fifth and sixth volumes to create a port on the upper surface of the substrate in liquid communication, via the liquid path, with the buried channel.

6. The method as recited in claim 1, wherein at least one of the first end of the input waveguide, the first end of the bar output waveguide and the first end of the cross output waveguide is positioned at least 3 μm from the channel.

7. The method as recited in claim 6, wherein the first end of the input waveguide, the first end of the bar output waveguide and the first end of the cross output waveguide are each positioned at least 3 μm from the channel.

8. The method as recited in claim 1, wherein etching the exposed first volume comprises exposing the exposed first volume to potassium hydroxide (KOH).

9. The method as recited in claim 8, wherein the potassium hydroxide is in an aqueous solution, and further comprising washing the substrate after exposing the first volume to KOH.

10. The method as recited in claim 1, wherein exposing the first volume to femtosecond laser light comprises 3-D writing the volume with a translation speed of no more than 3 mm/s.

11. The method as recited in claim 10, wherein exposing the first volume to femtosecond laser light comprises 3-D writing the first volume with a translation speed of around 1 mm/s.

12. The method as recited in claim 1, wherein etching the exposed first volume in the substrate to form the channel occurs after exposing the second volume, exposing the third volume and exposing the fourth volume.

13. The method as recited in claim 1, wherein exposing the first volume to femtosecond laser light comprises exposing the first volume with a first average optical power of femtosecond laser light and exposing at least one of the second, third, and fourth volumes comprises exposing the at least one of the second, third, and fourth volumes with a second average optical power of femtosecond laser light, the second average optical power being between two and four times the first average optical power.

14. An optical switch unit, comprising:
a substrate having at least one totally internally reflecting waveguide (TIRW) optical switch, the TIRW optical switch comprising
a channel in the substrate for carrying a liquid, the channel formed by femtosecond laser-induced chemical etching;
an input waveguide in the substrate on a first side of the channel, the input waveguide having a first end proximate the channel;
a bar output waveguide in the substrate on a second side of the channel across the channel from the first side, the bar output waveguide having a first end proximate the channel and positioned to receive light from the first and of the input waveguide that is transmitted across the channel;
a cross output waveguide on the first side of the channel having a first end proximate the channel and positioned to receive light from the input waveguide that is totally internally reflected at a first sidewall of the channel,
wherein the input waveguide, the bar output waveguide and the cross output waveguide are formed by femtosecond direct waveguide writing.

15. An optical switch unit as recited in claim 14, wherein the channel is formed open to an upper surface of the substrate, and further comprising a cover on the substrate to cover the channel.

16. An optical switch unit as recited in claim 14, wherein the channel is buried within the substrate.

17. An optical switch as recited in claim 16, wherein the substrate further comprises a port on an upper surface and a liquid path in liquid communication between the port and the channel.

18. An optical switch unit as recited in claim 14, wherein at least one of the first end of the input waveguide, the first end of the bar output waveguide and the first end of the cross output waveguide is positioned at least 3 μm from the channel.

19. An optical switch unit as recited in claim 14, wherein the first end of the input waveguide, the first end of the bar output waveguide and the first end of the cross output waveguide are each positioned at least 3 μm from the channel.

20. An optical switch unit as recited in claim 14, wherein the channel has a first sidewall at the first side and a second sidewall at the second side, the first and second sidewalls having a vertical height more than 100 μm and being vertically parallel within the substrate to within 1°.

21. An optical switch unit as recited in claim 14, wherein the channel has a first sidewall at the first side and a second sidewall at the second side, at least one of the first and second sidewalls having an rms surface roughness less than 100 nm.

22. An optical switch unit as recited in claim 14, wherein the optical switch unit comprises a multiplexer/demultiplexer.

23. An optical switch unit as recited in claim 14, wherein the optical switch unit comprises an N x N switch array.

24. An optical switch as recited in claim 14, wherein the channel has sidewalls having an rms surface roughness of less than 100 nm and opposing sidewalls of the channel are parallel to within 1°.
